(19) United States
(12) Patent Application Publication
(10) Pub. No.: US 2005/0260389 A1
(43) Pub. Date: Nov. 24, 2005

(54) System and method of making a layered, reinforced composite

(76) Inventors: Charles Beck, Newburyport, MA (US); Wayne Donohue, Salem, NH (US)

Correspondence Address: Barbara J. Carter;Bromberg & Sunstein LLP, 125 Summer Street, Boston, MA, 02110-1618, US

(21) Appl. No.: 11/082,234

(22) Filed: Mar. 16, 2005

Related U.S. Application Data
(63) Continuation of application No. 10/139,594, filed on May 6, 2002, now abandoned.
Application No. 10/139,594 is a continuation-in-part of application No. 09/934,263, filed on Aug. 21, 2001, now Pat. No. 6,890,586.
(60) Provisional application No. 60/289,610, filed on May 8, 2001.

(51) Int. Cl. B32B 3/14; B29C 41/22; B29C 71/02

(52) U.S. Cl. 428/156; 264/255; 264/236

(57) ABSTRACT

A system and method of making a layered, reinforced composite having an as-cured “Class A” surface. A mold (20) with a surface (200) having a predetermined degree of finish is heated to a temperature consistent with “in-molding coating” techniques applied to polyurethane-like matrix materials. The mold surface is coated with a first formulation to create an unreinforced topcoat (22) of the eventually cured composite. A second formulation is applied atop the topcoat to create an unreinforced barrier layer (23). A third formulation, comprising polymeric matrix material and reinforcements, is applied atop the barrier layer to create a reinforced layer (24). The combined topcoat, barrier layer, and reinforced layer making up an uncured preform are allowed to cure. The result is a reinforced composite with an as-cured “Class A” surface (210).

### RELATED CASES

The present application is a continuation of U.S. application Ser. No. 10/139,594 filed May 6, 2002, which is a continuation-in-part of regular patent application Ser. No. 09/934,263, filed Aug. 21, 2001, which claims priority from U.S. provisional application No. 60/289,610, filed May 8, 2001, of which each application is incorporated herein by reference in its entirety.

### TECHNICAL FIELD

The invention relates to the fabrication of reinforced polymeric matrix structures that exhibit a “Class A” surface finish. Such high quality surfaces are difficult to produce because of the “print-through” effect caused by the presence of a significant volume fraction of reinforcing material.

### BACKGROUND ART

Reinforcement of polymeric matrix and particularly polyurethane-based product beneficially saves weight and cost as well as improves mechanical properties for many applications. Particular applications include, but are not limited to, panels for farm combine vehicles, watercraft hulls, and tonneau covers.

Presently, reinforced polymeric matrix parts are typically made via established “spray up fiberglass” or sheet molding compound (SMC) processing. Most generally, SMC entails use of polyester resins, pigments, fillers, reinforcement fibers and additives that are mixed and, subsequently, are poured onto plastic film. The reinforcing fibers, in varying amounts and lengths, are added to yield the mechanical properties required for the particular application. A disadvantage to the established processes is the need to perform extensive post-mold operations to yield a finished part having any degree of gloss or smoothness. Further, it may not be possible for such a part to be economically produced having a “Class A” surface finish. Reinforcements may be fibrous having a significant length to diameter ratio. However, reinforcements may also be of a more generic shape and size. A reinforced composite having an as-cured “Class A” surface is herein defined as one having a surface which exhibits essentially no “print-through” effect of the reinforcement when that cured surface is removed from the mold. This “print-through” effect is normally prevalent when such a composite contains any reinforcement and especially when the reinforcements are fibers.

### SUMMARY OF THE INVENTION

In accordance with an embodiment of the present invention, a method of making a reinforced composite having an as-cured Class A surface is provided. The method includes providing a mold that has a mold surface having a predetermined degree of finish. The degree of finish is such that a mating surface of a cured polymer-based material fabricated in the mold would exhibit a Class A quality after cure. The mold is heated. It may be heated to a temperature of between approximately 37 degrees Celsius and approximately 94 degrees Celsius. This is an appropriate temperature for known “in-mold coating” techniques applied to polyurethane-like matrix materials. The method then includes coating the mold surface with a first formulation to create an unreinforced barrier layer of the eventually cured composite. A second formulation is applied atop the barrier layer to create a reinforced layer, the second formulation comprising polymeric matrix material and reinforcements. The reinforcements will generally be fibrous but may have other shapes that do not necessarily have a significant length to diameter ratio. The combined barrier layer and reinforced layer make up an uncured composite preform. Subsequently, the preform is allowed to cure so as to make a reinforced composite having an as-cured Class A surface.

The first and second formulations may comprise polyurethane and, more specifically, aromatic polyurethane. The reinforcements may be fibers and, more specifically, may be fiberglass. In order to hide the effects of the inclusion of fibers or other reinforcements from an observer of the Class A surface, the unreinforced barrier layer may have a thickness of between approximately 0.005 inches and approximately 0.250 inches; more specifically, a thickness of at least approximately 0.030 inches. Further embodiments include layered, reinforced composites made by the aforementioned method embodiments.

In yet another embodiment, the method further includes closing the mold after applying the second formulation. Pressure may then be applied to the closed mold and, therefore, force transferred to its contents to shape and to assist in curing the composite preform. This is particularly important if it is desired for the final composite to have shapes or other features apart from (on different surfaces or regions than) the Class A surface. These features may include but are not limited to ribs, bosses, or other strengtheners.

In a further embodiment, a method of making a reinforced composite having an as-cured Class A surface is provided. A mold having a mold surface with a predetermined degree of finish is provided; the degree of finish such that a mating surface of a cured polymer-based material fabricated in the mold would exhibit a Class A quality. The mold may be heated. A first formulation is coated onto the mold surface to create an unreinforced topcoat of the composite. A second formulation is applied atop the topcoat to create an unreinforced barrier layer. A third formulation is applied atop the barrier layer to create a reinforced layer, the third formulation comprising polymeric matrix forming material and reinforcements, so as to create an, as yet, uncured composite preform. The preform is then allowed to cure so as to make a reinforced composite having an as-cured Class A surface. Reinforced composites so formed are provided as additional embodiments.

### BRIEF DESCRIPTION OF THE DRAWINGS

The foregoing features of the invention will be more readily understood by reference to the following detailed description, taken with reference to the accompanying drawings, win which:

FIG. 1 is a sectional view (not to scale) of a reinforced structure in accordance with an embodiment of the invention; and

FIG. 2 is a sectional view (not to scale) of a filled mold in accordance with an embodiment of the invention.

### DETAILED DESCRIPTION OF ILLUSTRATIVE EMBODIMENTS

In accordance with embodiments of the present invention, developments in the area of “in-mold coating” of polyurethane parts have yielded fiber-reinforced composite parts exhibiting a Class A finish. This “in-mold coating technology” is, per embodiments, beneficially combined with a new glass fiber-reinforced polyurethane molding technique known as Long Fiber Injection (LFI). LFI is a technique currently used by Krauss-Maffei Kunststofftechnik GmbH, Munich, Germany (Krauss-Maffei). Kraus-Maffei markets and sells specialized equipment to perform the LFI technique. The combination of “in-mold coating” techniques with LFI molding processes has been used to successfully create Class A finish structures in an economic, reproducible fashion. It will be understood to those of skill in the art that structures formed using ways to introduce fibers or other reinforcements into a polymer other than LFI are also within the scope of the present disclosure.

In the most basic of terms, the final reinforced structure must exhibit a Class A finish upon cure and removal from a mold. For some applications, such a surface requires a high degree of gloss and smoothness. For other applications, a Class A surface may be one having low-gloss, smooth or even a mildly textured surface. An example of the latter is a subtle, leather-grain appearance that may be created by texturing the mold rather than polishing it to a high luster. In the continuum of Class A surfaces so described, it is the reinforcement “print-through” effect that is detrimental to the intended appearance. If the presence of reinforcements is not in some way concealed, they will “print-through” to the visible surface, disrupting the uniform, intended appearance of the top layer of the composite. The top surface is, in effect, roughened by what is present in the composite below.

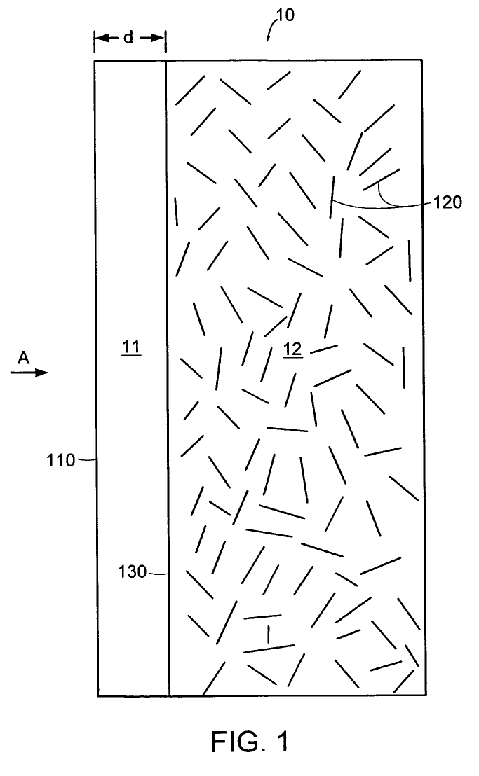

In accordance with an embodiment, a barrier layer is bonded to a reinforcement-containing layer so that, after curing, the resultant Class A surface is formed and remains of said quality after curing of both layers. The surface of interest, which is a part of the original barrier layer material, contains no reinforcement. Note that reinforcements are shown to be and are called fibers in the following embodiments; however, other shaped reinforcements are deemed to be within the scope of the embodiments. FIG. 1 illustrates a cross-section of a reinforced structure 10 after curing. When an observer looks at Class A surface 110 of structure 10 essentially along direction A, barrier layer 11 conceals from the observer the fact that reinforced layer 12 has reinforcing fibers 120 imbedded therein. Surface 110 may be of high gloss and smoothness and may display a mirror like image from objects displaced from surface 110 at some distance along axis A. Such a high gloss surface has the characteristic of being shiny. When a smooth and regular surface has high gloss, and does not exhibit significant curvature that might affect the reflection viewed therein, then it is possible that the scattering of incident light is minimal so that an observer can view light reflected by the high gloss surface as a distinct and usually recognizable image. In the absence of barrier layer 11, alternate surface 130 of structure 10 would not exhibit Class A gloss or smoothness and would exhibit a “print-though” effect due to the presence of fibers 120. Although Class A is a generic term and may mean different levels of quality in the realm of different applications and requirements, alternate surface 130 would not, in general, qualify as Class A. This is because, upon curing, reinforced layer 12 will exhibit an orange peel effect, general surface roughening, and have light scattering centers (the fibers 120 and or other defects not shown) proximal to surface 130. For the polyurethane-based systems tested to date, it has been experimentally determined that barrier layer 11 must have thickness d of at least 0.005 inches thick and should be at least 0.030 inches thick. Barrier layer 11 may be as thick as 0.250 inches thick; however, weight and cost considerations will likely preclude such a thick barrier layer 11. This minimum thickness d is still required if barrier layer 11 contains pigment (exhibits color). This is because the effects of the fibers 120, even though not resulting in direct fiber visibility when an observer views surface 110, will still cause surface 110 to not appear glossy or lustrous and will disqualify surface 110 from being Class A. It will be recognized that the materials and formulations used to make barrier layer 11 must be such that they will, upon curing of both barrier layer 11 and reinforced layer 12, form an acceptable bond between the layers that will resist delamination or other degradation during use within the intended service environment.

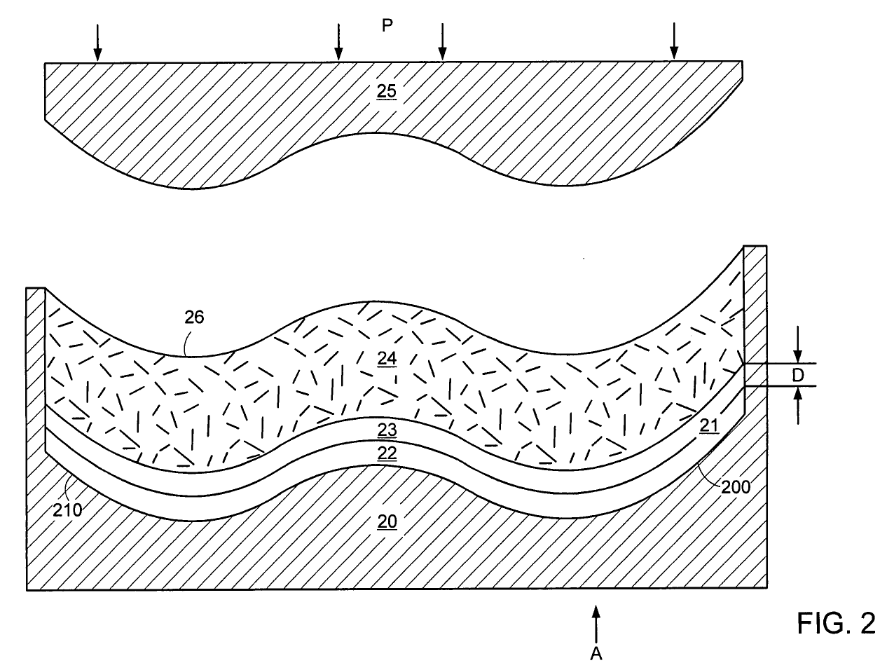

In general, the formulations suitable for use in creating barrier layer 11 and the resulting surface 110 may not be suitable for outdoor use. Direct sunlight, heat, acid rain, and other weather-related effects may play a major role in degrading the finish of surface 110 so formed. For such applications, in accordance with an embodiment, a filled mold 20 is illustrated in FIG. 2. A layered, fiber-reinforced composite 21 is shown to fill mold 20. Surface 210 becomes, upon cure and subsequent removal from mold 20, a Class A finish surface 210 requiring no further preparation. Composite 21 is shown to be made up of topcoat 22, barrier layer 23, and reinforced layer 24. As in the previously described embodiment, it is recognized that the materials and formulations used to make barrier layer 23 must be such that they will, upon curing, form an acceptable bond with both topcoat 22 and reinforced layer 24 so that the layers of composite 21 will resist delamination or other degradation during use within the intended service environment. There is a minimum barrier layer thickness, D, to be determined by the materials used to form that barrier layer 23 and also dependent on the type of reinforced layer 24 that is to be concealed when the cured composite 21 is removed from mold 20 and viewed by an observer essentially along axis A.

Topcoat 22 may, for example, be formulated from higher cost, aliphatic polyurethane. Aliphatic polyurethane is capable of maintaining, when compared with aromatic polyurethane, its new appearance after exposure to the elements. The topcoat 22 may, alternatively, be formulated as two (or more) layers; a second layer to provide color perceived by the end user. The multi-layer topcoat 22 is then opaque. As a user may not want the color to fade, the absolute top layer may be a clear layer that acts like a sunblocker to dramatically slow fading. Because the topcoat is opaque, the color of the barrier layer 23 does not matter. It is only important that it bond well to both the colored topcoat layer and the reinforced layer 24. Topcoat 22 may be applied to result in a thickness of between about 0.0005 inches to about 0.005 inches.

Topcoat 22 may be sprayed (or otherwise deposited) onto mold surface 200, thereby creating, after cure, Class A surface 210. Mold surface 200 has been prepared to exhibit minimal surface roughness. When polyurethane or other thermosetting materials are cured, the created part surface 210 will tend to match the smoothness and other characteristics of the mating mold surface 200. Mold surface 200 may be polished or otherwise smoothed to facilitate creation of a particular type of Class A composite surface 210. Highly polished nickel or chrome mold surfaces 200 are generally achieved by diamond polishing. Alternatively, mold surface 200 may be prepared to facilitate creation of another type of Class A composite surface 210 having a low-gloss or even a mildly textured surface. An example of the latter surface 210 is a subtle, leather-grain appearance that may be created by texturing the mold rather than by polishing it to a high luster. In the continuum of Class A surfaces so described, it is the reinforcement “print-through” effect that is detrimental to the intended appearance. Mold surface 200 is cleaned after polishing or otherwise appropriately prepared to avoid the inclusion of debris or other material within topcoat 22. Cleaning is defined herein to include various known techniques to remove grinding/polishing/other material from mold surface 200. Cleaning also encompasses removal of other dirt, debris, mold release materials from mold surface 200 and other parts of mold 20 which are not to play a direct role, in creating a Class A composite surface 210 or, more generally, layered composite 21.

Before spraying or otherwise applying topcoat 22 to mold surface 200, mold 20 should be heated. For polyurethane-based systems, mold 20 may be heated to a temperature of between approximately 37 degrees Celsius and approximately 94 degrees Celsius. Note that although mold 20 is usually heated, the fabrication methods disclosed should theoretically work at room temperature. Processing temperatures of reactants and mold 20 are chosen to provide a desired speed of composite processing. After application of topcoat 22, a second formulation is sprayed or otherwise placed atop topcoat 22. This material, when cured, will form barrier layer 23. Neither topcoat 22 nor barrier layer 23 contain reinforcement. As described above, barrier layer 23 effectively hides imperfections, inclusions, and defects from the view of an observer looking essentially in direction A at as-cured Class A surface 210. Barrier layer 23 has a minimum thickness D to accomplish this. Subsequent to placement of barrier layer 23 upon topcoat 22, reinforced layer 24 is applied atop barrier layer 23. Layer 24, if polyurethane-based, may be made up of foaming or non-foaming polyurethane. Fiberglass reinforcements may be part of layer 24.

The layered contents of mold 20 may be cured. Alternatively, closure 25 may be placed atop reinforced layer 24 in order to accommodate application of pressure, essentially along direction P to assist in curing composite 21. Although composite 21 may be fabricated using an open or closed mold 20, the incorporation of additional structural elements or molded features (not shown) on or near a back surface 26 would best be accomplished using a mating closure 25. These features may include but are not limited to ribs, bosses, or other strengtheners. One of skill in the art will understand that mold 20 need not be filled before closure 25 is placed in the case of foaming polyurethane. In this instance, it is desirable for closure 25 to be in place first with foaming to occur subsequently.

In general, a fast setting polyurethane barrier layer 23 is useful in forming reinforced polyurethane composites 21 exhibiting low-gloss, smooth or mildly textured surfaces where fiber print-through would be detrimental to the intended appearance. Another benefit of using a fast setting polyurethane barrier layer 23 is that when the composite 21 is removed from the mold 20, only subsequent washing and topcoating with a glossy paint is necessary to obtain a glossy Class A surface. This is what is known in the industry as “paint ready”, because the surface is uniform and smooth and accepting of subsequently applied coating upon cure. With other methods of polymeric matrix reinforcement, either the cycle time is too long or the surface 210 requires extensive sanding, priming, or other repair to enable creation of a Class A finish by eventual topcoating.

The combination of spray “in-mold coating” techniques (known formation of polyurethane from diisocyanate plus polyols) to create topcoat 22 and barrier layer 23 with LFI (new glass fiber-reinforced polyurethane molding technique known as Long Fiber Injection) molding processes to create reinforced layer 24 has been used to successfully create Class A finish structures in an economic, reproducible fashion. The layers 22, 23, and 24 must compatibly bond to one another upon cure and not delaminate in service.

The highly reactive polyurethane forming materials used to create topcoat 22 and barrier layer 23 tend to gel in place within seconds upon heated mold 20. Gel is a general term related to the extent of reaction of these forming materials. It is used to describe a noticeable occurrence of a transformation of the forming materials from a flowing, liquid-like state to a viscous, elastic-like state. It will be understood by those skilled in the art that gel of a first layer is requisite prior to application of subsequent layers. When such a fabrication approach is followed, subsequent application of reinforced layer 24 will not disturb previously formed layers to an extent that would be a detriment to the realization of the as-cured Class A surface of the composite 21.

The material used to create topcoat 22 may be a solvent based, two-component precursor of aliphatic polyurethane. Experiments have been performed with material containing between about 30 and about 60 volume fraction of solids. This material has a so-called “working time” once the two components are mixed of between approximately 20 and approximately 150 minutes. The solvents evaporate rapidly when this topcoat forming mixture is spray applied to the heated mold 20; the remaining reactants then gel “in place” in the mold 20 within seconds. Gelling typically occurs within about 30 to about 300 seconds.

The materials used to create the topcoat 22 may have the properties set forth in the following examples.

### EXAMPLE I

A two package aliphatic polyurethane for use as an in-mold coating for production of rim-injected polyurethanes:

Typical Properties:

| | |
|---|---|
| Gloss: | Dependent Upon Mold/Substrate |
| Weight per gallon: | 7.8-8.2 lbs./gallon |
| Viscosity: | 15-20 secs. GE #2 Zahn Cup |
| V.O.C. (as supplied): | 4.6 lbs./gallon |
| Solids by weight: | 40.4-44.4% |
| by volume: | 34.7-38.7% |
| Coverage: | 589 sq. ft./gal. @ 1 mil dft |
| Shelf life: | 12 months |

Application Data:

| | |
|---|---|
| Method: | Spray |
| Mix Ratio: | 2.0 Parts Paint: 1 Part 5758C00203 |
| | Reactor |
| Reduction: | n-butyl Acetate or EEP if necessary |
| Potlife: | 40-45 minutes at 25° C. to 150 cps |
| Substrate: | Rim-injected Polyurethane |
| Mold Temperature: | 140-190 degrees F. |
| Recommended dry film | 1.5-2.0 mils DFT |
| thickness: | |
| Clean up: | MIBK, MEK or Acetone |

### EXAMPLE II

A two package aliphatic polyurethane for use as an in-mold coating for production of rim-injected polyurethanes:

Typical Properties:

| | |
|---|---|
| Color: | Yellow |
| Gloss: | Dependent Upon Mold/Substrate |
| Weight per gallon: | 9.74-10.14 lbs./gallon |
| Viscosity: | 15-20 secs. GE #2 Zahn Cup |
| V.O.C. (as supplied): | 4.1 lbs./gallon |
| Solids by weight: | 56.4-60.4% |
| by volume: | 41.0-45.0% |
| Coverage: | 689 sq. ft./gal. @ 1 mil dft |
| Shelf life: | 12 months |

Application Data:

| | |
|---|---|
| Method: | Spray |
| Mix ratio: | 2.0 Parts Paint: 1 Part 758C30100 Reactor |
| Reduction: | Ethyl Acetate or MIBK if necessary |
| Potlife: | 25-35 Minutes at 25° C. to 150 cps |
| Substrate: | Rim-injected Polyurethane |
| Mold Temperature: | 140-190 degrees F. |
| Recommended dry | 1.5-2.0 mils DFT |
| Film thickness: | |
| Clean up: | MIBK, MEK or Acetone |

The materials used to form barrier layer 23 gel within approximately 5 seconds of being applied atop topcoat 22 onto heated mold 20. A slower reacting system for forming barrier layer 23 or use of a lower mold temperature would result in an extended gel time. Such variation in condition would still work as intended to create composite 21 if gel is allowed to occur prior to application of the subsequent reinforced layer 24.

The materials used to make reinforced layer 24 may gel in a time period of between 30 and 120 seconds for non-foaming systems. Alternatively, foaming systems may be used, where the foaming action or “creaming” is required prior to gel. In this case, “cream time” is typically between 25 and 120 seconds while the subsequent gel time is between 50 and 150 seconds.

Although various exemplary embodiments of the invention are disclosed above, it should be apparent to those skilled in the art that various changes and modifications can be made that will achieve some of the advantages of the invention without departing from the true scope of the invention.

1. A method of making a fiber-reinforced composite having an as-cured Class A surface, the method comprising:
a. providing a mold having a mold surface having a predetermined degree of finish; the degree of finish such that a mating surface of a cured polymer-based material fabricated in the mold would exhibit a Class A quality;
b. coating the mold surface with a first formulation to create an unreinforced barrier layer of the composite;
c. applying a second formulation atop the barrier layer to create a reinforced layer, the second formulation comprising polymeric matrix forming material and fibers, so as to create an, as yet, uncured composite preform; and
d. allowing the preform to cure so as to make a fiber-reinforced composite having an as-cured Class A surface.

2. A method according to claim 1 including the step of heating the mold to a temperature of between approximately 37 degrees Celsius and approximately 94 degrees Celsius.

3. A method according to claim 2 wherein the first and second formulations comprise polyurethane.

4. A method according to claim 3 wherein the first and second formulations comprise aromatic polyurethane.

5. A method according to claim 2 wherein the fibers comprise fiberglass.

6. A method according to claim 2 wherein the unreinforced barrier layer has a thickness between approximately 0.005 inches and approximately 0.250 inches.

7. A method according to claim 6 wherein the unreinforced barrier layer has a thickness of at least approximately 0.030 inches.

8. A method according to claim 2, further comprising:
a. closing the mold after applying the second formulation; and
b. applying pressure to the closed mold and its contents to shape and to assist in curing the composite preform.

9. A fiber-reinforced composite made according to claim 2.

10. A fiber-reinforced composite made according to claim 3.

11. A fiber-reinforced composite made according to claim 5.

12. A fiber-reinforced composite made according to claim 6.

13. A fiber-reinforced composite made according to claim 7.

14. A fiber-reinforced composite made according to claim 8.

15. A method of making a reinforced composite having an as-cured Class A surface, the method comprising:
a. providing a mold having a mold surface having a predetermined degree of finish; the degree of finish such that a mating surface of a cured polymer-based material fabricated in the mold would exhibit a Class A quality;
b. coating the mold surface with a first formulation to create an unreinforced topcoat of the composite;
c. applying a second formulation atop the topcoat to create an unreinforced barrier layer;
d. applying a third formulation atop the barrier layer to create a reinforced layer, the third formulation comprising polymeric matrix forming material and fibers, so as to create an, as yet, uncured composite preform; and
e. allowing the preform to cure so as to make a fiber-reinforced composite having an as-cured Class A surface.

16. A method according to claim 15 including the step of heating the mold to a temperature of between approximately 37 degrees Celsius and approximately 94 degrees Celsius.

17. A fiber-reinforced composite made according to claim 15.

18. A method according to claim 15 wherein the topcoat has a thickness between approximately 0.0005 inches and approximately 0.005 inches.

19. A method according to claim 15 wherein the topcoat comprises a plurality of layers.

20. A method according to claim 19 wherein the second layer is colored.

21. A method according to claim 15, further comprising:
a. closing the mold after applying the third formulation; and
b. applying pressure to the closed mold and its contents to shape and to assist in curing the composite preform.

22. A method according to claim 15 wherein the topcoat comprises a solvent based, two component precursor of aliphatic polyurethane.
